(19) United States
(12) Patent Application Publication
(10) Pub. No.: US 2022/0302532 A1
(43) Pub. Date: Sep. 22, 2022

(54) FLEXIBLE LI-ION BATTERIES

(71) Applicant: Tuqiang Chen, Albuquerque, NM (US)

(72) Inventor: Tuqiang Chen, Albuquerque, NM (US)

(21) Appl. No.: 17/207,479

(22) Filed: Mar. 19, 2021

(51) Int. Cl. H01M 50/136; H01M 4/36; H01M 4/505; H01M 4/525; H01M 4/74; H01M 4/66; H01M 10/0525; H01M 50/121

(52) U.S. Cl. CPC H01M 50/136; H01M 4/366; H01M 4/505; H01M 4/525; H01M 4/74; H01M 4/661; H01M 10/0525; H01M 50/121; H01M 2004/028

(57) ABSTRACT

The invention discloses a flexible Li-ion battery comprising a metal mesh current collector, where coated sequentially are patterned layers of an electrode material, a solid electrolyte, a second electrode material, a metal current collector and a flexible packaging material. The composite structures and the patterns of the materials coatings on metal mesh impart flexibility and foldability to the Li-ion batteries.

### STATEMENT REGARDING FEDERALLY SPONSORED R&D

None.

### FIELD OF INVENTION

The invention relates to the field of Li-ion batteries. More specifically, the invention relates to the field of flexible Li-ion batteries used for flexible electronics.

### BACKGROUND OF THE INVENTION

The advancement of flexible electronics has stimulated intensive efforts to search for corresponding energy storage devices that match their flexibility and bendability. Li-ion batteries are of great interest for development of flexible energy storage devices due to their high energy densities, layered cell structures, and possibly minimal amount of liquid involved.

A plausible approach to flexible energy storage devices is to develop flexible electrodes followed by integration of the electrodes into flexible devices. In this regard, tremendous efforts have been given in this area, including development of flexible electrodes and polymer electrolytes for Li-ion batteries or supercapacitors. The general approach to the development of flexible electrodes is having appropriate nanostructured active electrode materials embedded in or composited with a flexible substrate that may or may not be electrochemically active. For example, carbon nanotubes (CNTs), graphenes, carbon fibers, and carbon cloths have been used as the flexible substrates for making flexible Li-ion anodes and cathodes. These flexible electrodes do improve device flexibility; however, have significant limitations. The flexible electrodes are typically stacked and folded to form a device, which lacks sufficient adhesion between electrode layers to hinder delamination when devices are subject to repeated bending or folding. New approaches to fabrication flexible Li-ion batteries or supercapacitors, including lamination, vacuum infiltration, coating, winding, or printing, have been investigated to form flexible energy storage devices of various configurations; however, none of them seem to be viable for large scale mass production.

In recent years, efforts have been made to improve performances of Li-ion batteries and supercapacitors involving utilization of metal mesh instead of metal foil as current collectors. Shi, et al. reported in a research article (Nano Energy, 2014, 6, 82-91) a flexible supercapacitor, prepared by deposition of carbon materials on stainless steel (SS) mesh, followed by assembly of a pair of mesh electrodes sandwiching a separator that is wetted with an organic electrolyte. Unfortunately, due to lack of sufficient adhesion between electrodes and separator, repeated bending may lead to failure of the supercapacitor due to layer separation. Chen disclosed a 3-D Li battery and a supercapacitor in a US patent (U.S. Pat. No. 9,905,370), where ultrafine metal mesh (UMM) was used as current collector. Thin films of electrode materials and solid state electrolytes were sequentially deposited onto the surfaces of the ultrafine metal mesh wires, forming UMM-based electrodes. The UMM-based anodes and cathodes were alternately stacked and laminated using the electrolyte as adhesive, forming mesh-based 3-D energy storage devices for better electrochemical and mechanical performance characteristics. The metal mesh substrates along with the laminated coating structures of the electrode materials and polymer electrolytes, forming a micro-composite structure, impart certain degrees of flexibility to the 3-D Li-ion batteries and supercapacitors; however, insufficient for substantial folding or bending.

These mesh-based electrodes, compared with conventional foil-based electrodes, allow loading of more electrode materials for improved performance characteristics due to higher porosity of mesh. These include higher energy and power densities. Additionally, a mesh substrate, having pore structures and high surface area, promotes better bonding between electrode materials and the substrate. The novel structures of mesh-based energy storage devices disclosed in the US patent (U.S. Pat. No. 9,905,370) also allow significant improvement over device flexibility, because the energy storage device is a metal wire reinforced composite having a continuous polymer electrolyte matrix. This improves flexibility and reduces risk of delamination upon bending or folding. However, it must be realized that polymer electrolytes are not intended for structural applications, they may not have the mechanical strength to withstand repeated bending or folding of a flexible device. Therefore, additional features of the flexible energy storage devices were introduced to significantly improve flexibility and bendability of the devices as disclosed in a US patent application (US 2020/0321619 A1). Owing to the open structure of the metal mesh, a flexible packaging material was introduced, as a patterned, well distributed matrix phase of the mesh-based energy storage device, which significantly improved device flexibility and bendability.

The flexible energy storage devices disclosed in US patent application (US 2020/0321619 A1), however, have at least one patterned mesh-based anode and one patterned mesh-based cathode that are prepared by depositing of anode and cathode materials respectively onto separate metal mesh current collectors, followed by lamination of the two patterned electrodes that must be aligned well to each other, to ensure the flexible packaging material to bond to themselves through the open pore structures of the anode and the cathode. This, of course, improves resistance to delamination due to the flexibility and mechanical strength of the packaging material; however, it may still delaminate as this is still a two layered structure that some areas of the two coated mesh sheets are still bonded with mechanically weaker polymer electrolyte.

### SUMMARY OF THE INVENTION

These and other objectives are achieved in the present invention by 1) utilization of a metal mesh as substrate and current collector, and 2) sequentially deposition of patterned coatings on metal mesh wires of a first electrode, an electrolyte, a second electrode, a metal coating as second current collector, and a flexible packaging material, to produce a single mesh based Li-ion battery.

Accordingly, it is an object of the present invention to claim a flexible, foldable Li-ion battery by sequential deposition of a patterned electrode material, an electrolyte, a second electrode material, a second metal current collector and a flexible packaging material on a flexible metal mesh substrate. It is another objective of the invention to further disclose the flexible Li-ion battery with features for folding and flexing functionalities. The coatings of the electrode, the electrolyte, the second electrode, and the second current collector are cylindrical in nature around metal mesh wire, which improve resistance to delamination between the layers upon repeated bending. There is at least one primary linear strip of flexible packaging material phase in the device, where only metal mesh is embedded, which facilitates folding of the claimed energy storage device along the strip axis. The primary strip or strips may divide the claimed Li-ion battery into two or more sub cells, which may be considered being connected in parallel.

### BRIEF DESCRIPTION OF THE DRAWINGS

The principle of the present invention may be understood with reference to the detailed description, in conjunction with the accompanying drawings, in which:

FIG. 1 shows a plan view of a metal mesh current collector (10).

FIG. 2 shows a cross-sectional view of a coated mesh wire (lengthwise), illustrating detailed structural relations of mesh wire, coatings of electrodes, electrolyte, and packaging material.

FIG. 3 shows a cross-sectional view of two adjacent coated mesh wires (crosswise), illustrating detailed structural relations of mesh wire, coatings of electrodes and electrolyte, and packaging material.

FIG. 4 shows a cross-sectional view of a plane in parallel with mesh plane (10) and on top of second electrode current collector film (18), illustrating structural features of primary (20A) axis of the Li-ion battery.

FIG. 5 shows a cross-sectional view of the Li-ion cell (30), illustrating structural features of flexible packaging material (20), and primary flexible axis (20A).

### DETAILED DESCRIPTION OF THE INVENTION

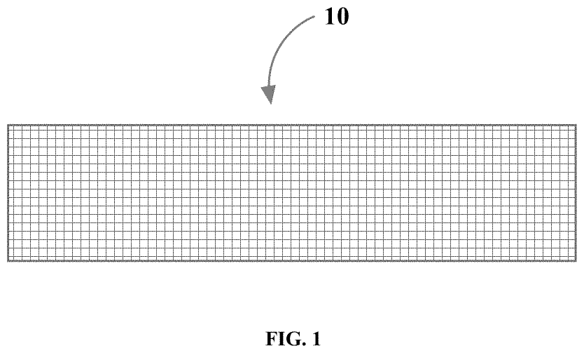

Referring now to FIG. 1 of the drawings, is metal mesh 10 used as current collector for conducting current, and as structural substrate for deposition of electrode and electrolyte materials and for structural flexibility as well. Any suitable metals may be used for metal mesh 10, with Al, Cu, Ni, Sb, Cr, Fe, Pt, or Si as an example. It is noted that, in comparison with metal foil substrate of equivalent dimension (thickness and area), metal mesh shows higher porosity and specific surface area, which promote higher loading of electrode materials for higher energy density and power density. While it is understood that smaller wire diameter and larger pore/opening size of mesh are favored for higher loading of active materials, thus, better electrochemical performance, however, the structural and mechanical performance of the claimed device may be sacrificed substantially. In addition, it may become extremely challenging for electrode and electrolyte deposition processes when the thickness of the mesh is reduced to submicron range. Therefore, the mesh wire diameter and mesh pore/opening size may have to be varied, for example, from 1 to 100 microns for a balanced overall performance for a specific application.

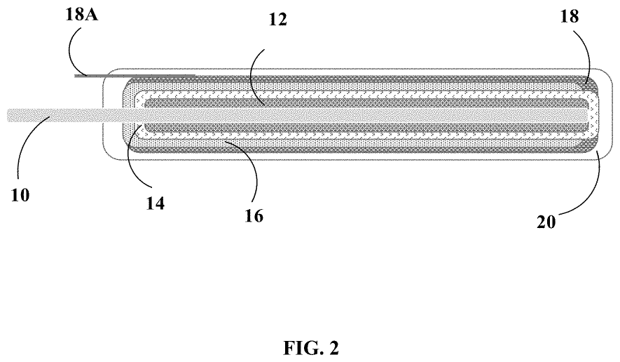

Referring to FIG. 2 of the drawings, is a cross-sectional view (lengthwise) of a coated metal mesh wire, showing relations of the wire (10), first electrode (12), the electrolyte (14), the second electrode (16), the metal film current collector (18), and the flexible packaging material (20). As can be seen, the first electrode material is deposited on the surface of the mesh wire, which may be chemically or physically treated for roughness, for improved surface bonding. The electrolyte is deposited on top of the first electrode layer, covering the electrode layer completely. The second electrode is deposited on top of the electrolyte layer without being in contact with the metal mesh. The second metal current collector (18) is deposited on top of the second electrode layer, covering the second electrode and the electrolyte layer without being in contact with the metal mesh (10). A metal tab (18A) is bonded on the metal film current collector layer and extended out of the packaging material layer (20), which fully covers the electrolyte layer. The structure illustrated in FIG. 2 ensures complete insulation between the first electrode, including 10 and 12, and the second electrode, including 16 and 18. The device is sealed hermetically with the packaging material and the metal coating/film of the second electrode current collector, which is critical for the performance and safety of Li-ion batteries.

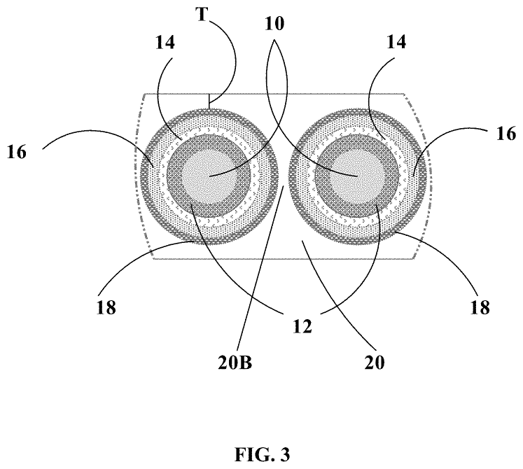

Referring to FIG. 3 of the drawings, is a cross-sectional view of two adjacent coated mesh wires, illustrating the relations of the metal wire (10), the first electrode (12), the electrolyte (14), the second electrode (16), the metal film current collector (18), and the flexible packaging material (20) with a defined thickness T for the packaging layer. It can be seen that all of these coating layers may be cylindrical in nature, except the flexible packaging material. The cylindrical coating layers of these materials are closed structure around the metal mesh wire, significantly hindering delamination of these layers in comparison with planar layered structure for traditional Li-ion batteries. Additionally, the top layer of 20, may be bonded through the unfilled metal mesh opening (20B) to the bottom layer of 20, which may improve flexibility of the mesh based battery.

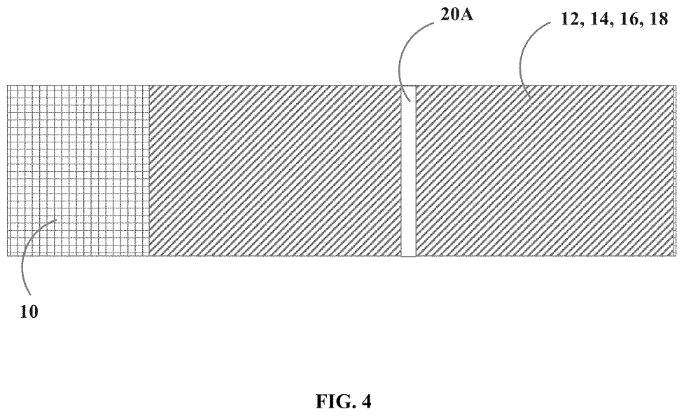

Referring to FIG. 4 of the drawings, 4 shows a cross-sectional view of a plane in parallel with mesh plane (10) and on top of second electrode current collector film (18), illustrating structural features of primary (20A) axis of the Li-ion battery. As can be seen in FIG. 4, electrodes, electrolyte, and second metal current collector coatings are deposited on metal mesh in a pattern that a primary strip 20A is only filled with flexible packaging material 20. Primary strip 20A may separate battery 30 into two cells, and it may functions as a bending axis allowing battery 30 to fold. In addition, these two independent cells are well sealed and packaged, and each may function properly if separated.

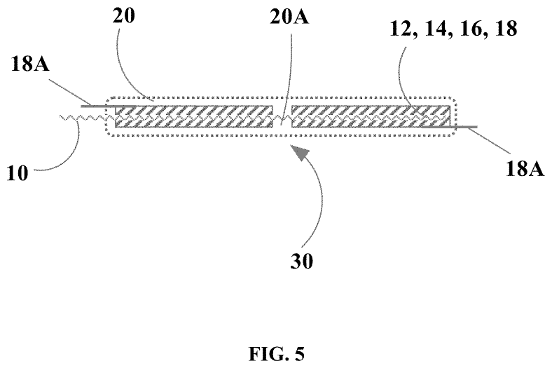

Referring to FIG. 5 of the drawings, is a cross-sectional side view of the Li-ion cell 30, illustrating structural features of flexible packaging material 20 and primary flexible axis 20A, which may show foldability around 20A from a different view.

Like in previously disclosed 3-D mesh-based energy storage devices (Chen, U.S. Pat. No. 9,905,370 and US 2020/0321619 A1), the electrode coatings adhere more strongly to metal wire surfaces than they do to metal foil. This is because cylindrical coatings on mesh wires have a closed structure and mesh has higher surface area than foil. Likewise, subsequent electrolyte coatings are bonded more strongly on the cylindrical electrode coatings. This is a great attribute for flexible electrodes, as the strong adhesions of the coatings significantly hinder delamination between these layers from repeated bending or folding.

Contrary to previously disclosed mesh-based flexible Li-ion batteries (Chen, U.S. Pat. No. 9,905,370 and US 2020/0321619 A1) that the first electrode (12) and second electrode (16) are deposited on separate metal mesh and aligned and laminated subsequently, the present invention has the first electrode (12) and second electrode (16) on the same metal mesh wire, which may lead to a thinner battery with more structural flexibility and eliminate possibility of delamination between two coated metal meshes. It is worth noting that battery 30 is essentially a metal wire/fiber reinforced inorganic/organic/metal composite, which may provide the battery with significantly improved overall electrochemical and structural performance.

Li-ion batteries, as energy storage devices, commonly use a metal oxide as cathode and a carbon material as anode. In the present invention, the first electrode may be a Li-ion anode and the second a cathode, or vice versa. In one embodiment of the invention, the first electrode may not be present initially, instead, upon initial charge, it is formed as a thin layer of Li metal deposited at the interface of the metal wire and the electrolyte, when the second electrode is a Li-ion cathode.

In another embodiment where the first electrode is a cathode, the second electrode may not be present initially and is formed at the interface of the electrolyte and the metal film current collector upon initial charge. This and the previous embodiments are preferred in the invention as they may exemplify a reduced total thickness and simplified fabrications of the device.

While in other embodiments of the invention, both first and second electrodes are required to be present in the beginning. Any suitable Li-ion battery cathode materials may be used in the first or second electrode layer, with LiCoO₂, LiNiO₂, LiMn₂O₄, LiFePO₄, or LiNiₓCo_{y}Mn_{z}, as an example. Any suitable Li-ion anode material may be used in the first or second electrode layer in the invention, with graphite, Si, or LiTiO (Li₄Ti₅O₁₂, spinel) as an example. Any suitable polymer or ceramic electrolytes may be used in the electrolyte layer in the invention. Any suitable metal may be used in the second electrode current collector layer, with Al, Cu, Ni, Pt, or Au, as an example.

A flexible polymeric packaging materials may be used to enclose and/or infiltrate the multilayer coated mesh. Any suitable flexible polymeric materials may be used to enclose the device, with polysiloxane, polyurethane, polyester (PET), polyimide (PI), polyethylene naphthalate (PEN), polyetherimide (PEI), and fluropolymers or copolymers as an example. The thickness of the flexible polymer packaging layer (T) may range, for example, from 1 to 100 microns. It is worth noting that the packaging material fills all of the porous structures of the primary folding strip (20A), the unblocked mesh holes (20B), and the edges of the coated mesh wires, which transforms the energy storage device into a flexible, metal mesh/fiber reinforced ceramic/polymer composite.

The first electrode material layer may be deposited in a number of ways, including wet chemical, vapor, or electrochemical techniques. The first electrode layer on mesh wire surface may not cover the mesh holes fully, and the thickness of first electrode may range, for example, from 1 micron to 25 microns. The electrolyte material layer may be deposited in a number of ways, including wet chemical, vapor, or electrochemical techniques and it may not cover the mesh holes fully, and the thickness of electrolyte may range, for example, from 0.5 micron to 25 microns. The second electrode material layer may be deposited in a number of ways, including wet chemical, vapor, or electrochemical techniques and it may not cover the mesh holes fully, and the thickness of the layer may range, for example, from 1 micron to 25 microns. The current collector layer for the second electrode may be deposited in a number of ways, including wet chemical, vapor, or electrochemical techniques and it may or may not cover the mesh holes fully, and the thickness may range, for example, from 0.1 micron to 10 microns.

Having generally described the invention, the following examples serve to illustrate the preferred embodiments of the present invention and should not be construed as limiting the scope of the invention:

### EXAMPLE 1

### A Mesh Based Flexible Li-Ion Battery without Initial Anode (First Electrode) and Flex Axis 20A

A Ni mesh (3×6 cm², opening 5 microns, wire diameter 2 microns) was first soaked in a NaOH solution (1.0 M) at 60° C. for 16 hrs, then cleaned by repeated soaking and sonicating in 50% isopropyl alcohol (IPA) for 16 hrs, and dried in an oven at 120° C. for 1 hr. The mesh sample was clamped with four Al spacer bars (0.5 cm×0.5 cm×5 cm) at the two ends of the rectangular mesh and suspended on top of an Al plate (5×5 cm²) using 4 small screws at each of the four corners of the square Al plate. The suspended mesh on Al plate was placed on a spin coater.

A LiₓPO_{y}N_{z} (LiPON-like) ceramic electrolyte precursor solution was prepared as follows: A solution of lithium acetate, (Li(CH₃COO)₂.2H₂O, 5.10 g, 0.05 mol, in 100 mL of 50% IPA) was mixed with a solution of H₃PO₄ (49.5%, 0.017 mol) and ethylenediamine (15.0 g, 0.25 mol) in a 250-mL flask at room temperature. The resulting solution was heated under reflux for 6 hrs and cooled to room temperature, ready for subsequent spin-coating.

The precursor solution was added onto the surface of the mesh that was suspended on top of the Al plate and placed on a spin-coater. The precursor solution was allowed to conditioning for 30 seconds, permitting complete wetting on both sides of the mesh, followed by spinning at 1200 rpm for 15 seconds. The coating was first dried in air at 160° C. for 16 hrs followed by heating at 400° C. in air for 4 hrs and 850° C. in N₂ for 8 hrs, forming thin films of LiₓPO_{y}N_{z} ceramic electrolyte. X-ray diffraction (XRD) confirmed formation of an amorphous phase of the and SEM study revealed formation of uniform coating with a thickness of ˜0.5 micron.

The Ni mesh coated with LiₓPO_{y}N_{z} was further coated with a LiCoO₂ cathode. The preparation and processing of the cathode film were described as follows:

A LiCoO₂ precursor solution was prepared as follows: A solution of lithium acetate, (Li(CH₃COO)₂.2H₂O, 5.10 g, 0.05 mol, in 50 mL 50%) was mixed with a solution of cobalt acetate, (Co(CH₃COO)₂.4H₂O, 12.55 g, 0.05 mol in 50 mL 50% IPA) and poly(ethylene glycol) (8.80 g, 0.2 mol) in a 250-mL flask at room temperature. The resulting pink-colored solution was heated under reflux for 6 hrs and cooled to room temperature, ready for subsequent spin-coating.

With the peripheries of the electrolyte coated Ni mesh being covered with a polyimide (PI) tape on both sides, a small portion of the LiCoO₂ precursor solution was added on the surface of the ceramic electrolyte coating on the Ni mesh and conditioned for 30 seconds, permitting complete wetting on both sides of the coated mesh, followed by spinning at 1200 rpm for 10 seconds. The coating was first dried in air at 160° C. for 16 hrs, followed by removing polyimide tapes and heating at 400° C. in air for 4 hrs and 850° C. in N₂ for 8 hrs, forming thin films of LiCoO₂. X-ray diffraction (XRD) confirmed formation of crystalline LiCoO₂ and SEM study revealed formation of uniform coating. This process was repeated until the thickness of LiCoO₂ layer became ˜2 microns.

With the peripheries of the electrolyte and LiCoO₂ coated Ni mesh being covered with polyimide tape once again, the LiCoO₂ surface was metalized with aluminum by vacuum deposition with an Al film thickness of ˜0.5 micron. During the deposition process, the coated mesh was rotated along X- and Y-axes to ensure a uniform Al deposition round coated metal mesh wires. An aluminum foil tab (18A) was glued onto the aluminum film using an electrically conductive adhesive.

The metalized mesh based battery was immersed in a 18 wt % polyimide solution in DMAc (N,N-Dimethylacetamide) for 5 min. and slowly lifted out of the solution. The coated mesh was then heated in dry air at 100° C. for 30 min and 300° C. for another 30 min. The thickness of the packaging polymer film was ˜2 microns and most of the pores (20B) left prior to the packaging were filled completely. The well packaged mesh-based Li-ion battery showed excellent flexibility and can be cycled repeatedly following initial charge.

### EXAMPLE 2

### A Mesh Based Flexible Li-Ion Battery without Initial Anode (First Electrode)

A Ni mesh (3×6 cm², opening 5 microns, wire diameter 2 microns) was first soaked in a NaOH solution (1.0 M) at 60° C. for 16 hrs, then cleaned by repeated soaking and sonicating in 50% isopropyl alcohol (IPA) for 16 hrs, and dried in an oven at 120° C. for 1 hr. The surface treated Ni mesh was marked/covered with a polyimide tape on strip 20A, with a width of 100 microns. The PI marked mesh sample was clamped with four Al spacer bars (0.5 cm×0.5 cm×5 cm) at the two ends of the rectangular mesh and suspended on top of an Al plate (5×5 cm²) using 4 small screws at each of the four corners of the square Al plate. The suspended mesh on Al plate was placed on a spin coater.

The LiₓPO_{y}N_{z} (LiPON-like) ceramic electrolyte precursor prepared as described in Example 1, was added onto the surface of the mesh that was suspended on top of the Al plate and placed on a spin-coater. The precursor solution was allowed to conditioning for 30 seconds, permitting complete wetting on both sides of the mesh, followed by spinning at 1200 rpm for 15 seconds. The coating was dried in air at 160° C. for 16 hrs first followed by heating at 400° C. in air for 4 hrs, and 850° C. in N₂ for 8 hrs after PI tape was removed, forming patterned thin films of LiₓPO_{y}N_{z} ceramic electrolyte. X-ray diffraction (XRD) confirmed formation of an amorphous phase of the electrolyte and SEM study revealed uniform coating with a thickness of ˜0.5 micron.

With the peripheries and strip of 20A of the electrolyte coated Ni mesh being covered with polyimide (PI) tape on both sides, a small portion of the LiCoO₂ precursor solution prepared as described in Example 1, was added on the surface of the coating on the Ni mesh and conditioned for 30 seconds, permitting complete wetting on both sides of the coated mesh, followed by spin at 1200 rpm for 10 seconds. The coating was first dried in air at 160° C. for 16 hrs, followed by removing polyimide tapes and heating at 400° C. in air for 4 hrs and 850° C. in N₂ for 8 hrs, forming thin films of LiCoO₂. X-ray diffraction (XRD) confirmed formation of crystalline LiCoO₂ and SEM study revealed formation of uniform coating. This process was repeated until the thickness of LiCoO₂ layer was ˜2 microns.

With the peripheries of the electrolyte and LiCoO₂ coated Ni mesh being covered with polyimide tape once again, the LiCoO₂ surface was metalized with aluminum by vacuum deposition with a film thickness of ˜0.5 micron. During the deposition process, the coated mesh was rotated along X- and Y-axes for a uniform Al deposition round coated metal wires. A couple of aluminum foil tabs (18A) were glued onto the aluminum film current collector using an electrically conductive adhesive.

The metalized mesh-based battery without any PI tape strips attached was lowered into a 18 wt % polyimide solution in DMAc (N,N-Dimethylacetamide) for 5 min. and slowly lifted out of the solution. The coated mesh was then heated in dry air at 100° C. for 30 min and 300° C. for another 30 min. The thickness of the packaging polymer film was 2 microns and most of the unfilled pores (20B) and strip of 20A were filled completely. The well packaged mesh-based Li-ion battery showed excellent flexibility and foldability around primary axis 20A. It can be cycled repeatedly following initial charge.

In conclusion, the invention discloses a solid-state, flexible Li-ion battery that is built on a sheet of ultrafine metal mesh wires by sequential deposition of patterned films of first electrode, electrolyte, second electrode, second electrode current collector, and flexible packaging material. The claimed solid-state, flexible Li-ion battery shows improved electrochemical and mechanical properties that are crucial to the development of new advanced mobile and portable electronics.

The embodiments of the present invention described above are exemplary. Many changes and modifications may be made to the disclosures recited above, while remaining within the scope of the invention. The scope of the invention should, therefore, be determined not with reference to the above description, but instead should be determined with reference to the appended claims, along with their full equivalents.

What is claimed:

1. A flexible Li-ion battery comprising: a) a metal mesh current collector, b) a cylindrical layer of first electrode material deposited with pattern on said metal mesh wires, having uncoated mesh pore structures, c) a cylindrical layer of a solid electrolyte deposited on said first electrode material layer, d) a cylindrical layer of a second electrode material deposited on said electrolyte layer, e) a cylindrical layer of a metal current collector deposited on said second electrode material layer, and f) a layer of flexible polymer packaging material deposited on said cylindrical layer of metal film current collector, and said polymer packaging material fills in said mesh pore structures.

2. The flexible Li-ion battery of claim 1, wherein said mesh pore structures comprising voids of each of mesh openings that not fully filled with electrode, electrolyte, and metal film current collector materials.

3. The flexible Li-ion battery of claim 1, wherein said mesh pore structures comprising at least one linear strip of bare metal mesh with strip width ranging from 5 μm to 10 mm.

4. The flexible Li-ion battery of claim 1, wherein said metal mesh current collector comprising: a material selecting from the group consisting of Al, Cr, Cu, Fe, Ni, Sb, Pt, and Si, having a wire diameter ranging from 1 to 100 μm and a mesh pore size ranging from 1 to 100 μm.

5. The flexible Li-ion battery of claim 1, wherein said layer of first electrode material is NOT present, wherein said layer of second electrode material is a Li-ion cathode material, comprising a material selecting from the group consisting of LiCoO₂, LiNiO₂, LiMn₂O₄, LiFePO₄, and LiNiₓCo_{y}Mn_{z}, and having a thickness ranging from 1 to 25 μm.

6. The flexible Li-ion battery of claim 1, wherein said layer of first electrode material is a Li-ion anode material having a thickness of 1 to 25 μm, comprising a material selecting from the group consisting of silicon, graphite and LTO, wherein said layer of second electrode material is a Li-ion cathode material having a thickness of 1 to 25 μm, comprising a material selecting from the group consisting of LiCoO₂, LiNiO₂, LiMn₂O₄, LiFePO₄, and LiNiₓCo_{y}Mn_{z}.

7. The flexible Li-ion battery of claim 1, wherein said layer of first electrode material is a Li-ion cathode material having a thickness of 1 to 25 μm, comprising a material selecting from the group consisting of LiCoO₂, LiNiO₂, LiMn₂O₄, LiFePO₄, and LiNiₓCo_{y}Mn_{z}, and wherein said layer of second electrode material is NOT present.

8. The flexible Li-ion battery of claim 1, wherein said layer of first electrode material is a Li-ion cathode material having a thickness of 1 to 25 μm, comprising a material selecting from the group consisting of LiCoO₂, LiNiO₂, LiMn₂O₄, LiFePO₄, and LiNiₓCo_{y}Mn_{z}, and wherein said layer of second electrode material is a Li-ion anode material having a thickness of 1 to 25 μm, comprising a material selecting from the group consisting of silicon, graphite, and LTO.

9. The flexible Li-ion battery of claim 1, wherein said layer of solid electrolyte layer comprising a material selecting from the group of a polymer electrolyte and a ceramic electrolyte, and wherein said electrolyte layer has a thickness ranging from 0.5 to 25 μm.

10. The flexible Li-ion battery of claim 1, wherein said layer of metal film current collector comprising a material selecting from the group of Al, Cu, Ni, Pt and Au, and wherein said layer of the metal film current collector has a thickness ranging from 0.1 to 10 μm.

11. The flexible battery of claim 1, wherein said flexible polymer packaging layer comprising a material selecting from the group consisting of polysiloxane, polyurethane, polyester (PET), polyimide (PI), polyethylene naphthalate (PEN), polyetherimide (PEI), and fluropolymers and copolymers, and wherein said flexible polymer packaging layer has a thickness ranging from 1 to 100 μm.
